(19) United States
(12) Patent Application Publication
(10) Pub. No.: US 2010/0089482 A1
(43) Pub. Date: Apr. 15, 2010

(54) METHOD FOR PRODUCING DUCTWORK CONNECTING COMPONENTS FOR AIR-HANDLING SYSTEMS, CONNECTING COMPONENTS AND AIR-HANDLING SYSTEM

(76) Inventor: Peter Lorincz, Budapest (HU)

Correspondence Address: DOWELL & DOWELL P.C., 103 Oronoco St., Suite 220, Alexandria, VA, 22314, US

(21) Appl. No.: 12/449,072

(22) PCT Filed: Jan. 24, 2008
(86) PCT No.: PCT/HU2008/000007

§ 371 Date: Dec. 7, 2009

(30) Foreign Application Priority Data
Jan. 25, 2007 (HU) P0700087

(51) Int. Cl. F16L 9/14; B32B 38/04

(52) U.S. Cl. 138/143; 156/256; 138/149; 138/DIG. 11

(57) ABSTRACT

The present invention relates to a method for producing ductwork connecting components (1) preferably for air-handling systems. The essence of the invention lies in that providing a foam-related material made of chemically cross-linked polyolefine with closed cell-structure, preparing the pattern (4) of a connecting component from a foam-sheet of polyolefine, cutting out the pattern and forming the final shape of the connecting component by welding the corresponding edges. The present invention relates further on to connecting components prepared according to the method of the invention. The invention also relates to an air-handling system using the connecting components of the invention.

### FIELD OF THE INVENTION

The present invention relates to a method for producing ductwork connecting components for air-handling systems such as commercial or industrial ventilation and air-conditioning, connecting components having preferably a circular cross section and being formed from a heat insulating material. The invention further relates to an air-handling system comprising the ductwork connecting components made according to the invention.

### BACKGROUND OF THE INVENTION

The different air-handling systems are made of duct elements arranged according to a given plan and the duct elements are coupled by means of connecting components. The ductwork components may include ducts (straight or bent), boots, registers, tees, reducers, etc., hereafter referred as connecting components. Both the duct elements and the connecting components are generally made of metal in order to assure their durability and they are provided with a single-layer or multilayer insulation, if needed. Producing such systems are quite expensive, and their assembling, especially their maintenance and/or replacement is very difficult.

### SUMMARY OF THE INVENTION

It has been recognized that instead of using metal for producing the duct elements and/or connecting components of air-handling systems, using a kind of plastic material proposed for air-handling purposes makes it possible to provide air-handling systems being less complicated and exhibiting superior handling, performance and aesthetic properties. According to the experiences and observations the chemically cross-linked polyethylene with closed cell-structure, i.e. the polyolefine foam is the one being applicable for this aim. The duct elements can be made by winding up said polyolefine foam on one hand and said material can also be used for preparing the connecting components of the ductwork on the other hand.

The object of the present invention is a method for producing ductwork connecting components, such as elbows, tees, boots, reducers, take-off-s for air-handling systems by preparing first the pattern of a given connecting component. Next cutting the pattern out, and at last preparing the final shape of the connecting component by welding the corresponding edges.

The chemically cross-linked polyolefine with closed cell-structure, hereafter polyolefine foam, being the raw material will advantageously be covered with an evaporized metal layer before cutting on one side, or it can be covered with another non-metal film layer on the other side.

Another object of the present invention is a ductwork connecting components made according to the invention used preferably for air-handling systems, said connecting components comprising a polyolefine foam being preferably strengthened with metal along the connecting edges.

The connecting components are advantageously provided with evaporized metal layer on the outer surface. The bulk density of the sheet material made of polyolefine foam is in the range of 30-90 kg/m³.

The invention relates further on to an air-handling system comprising ductwork connecting elements prepared according to the invention.

### BRIEF DESCRIPTION OF THE DRAWINGS

The present invention will now be appeared in more detail with the help of the enclosed figures, where

FIG. 1 shows in lateral view a duct element coupled with a connecting component prepared according to the invention and having the same diameter as that of the duct and arranged in an angle of 45° in relation to the axis of the duct element,

FIG. 2 shows in lateral view a duct element coupled with a connecting component according to the invention prepared as a reducer and arranged in an angle of 45° in relation to the axis of the duct element,

FIG. 3 shows in lateral view a duct element coupled with a connecting component according to the invention being bent in an angle of 45° in relation to the axis of the duct element,

FIG. 4 shows in lateral view a connecting component according to the invention being bent in an angle of 90° in relation to the axis of the duct element,

FIG. 5 shows in lateral view a straight duct element provided with a sound-damping layer,

FIG. 6 shows in lateral view a connecting component according to the invention being bent in an angle of 90° in relation to the axis of the duct element and provided with a sound-damping layer,

FIG. 7 shows in lateral view a connecting component according to the invention being formed as a reducer being not coaxial with the duct element to be coupled to,

FIG. 8 shows a boot in lateral view,

FIG. 9 shows a coupling member for the connecting component in lateral view,

FIG. 10 shows a reducer in lateral view,

FIG. 11 shows a tee in lateral view, where the diameter of the tee is the same as that of the duct to be coupled to,

FIG. 12 shows a tee in lateral view, where the diameter of the tee is different from that of the duct to be coupled to,

FIG. 13 shows a supporting component for an air grid in lateral view,

FIG. 14 shows an end-closure in lateral view,

FIG. 15 shows a support element in top view,

FIGS. 16-18 show different duct elements (being fixed, flexible and perforated) in lateral view, and

FIGS. 19-20 show cut patterns.

### DETAILED DESCRIPTION OF THE PREFERRED EMBODIMENTS

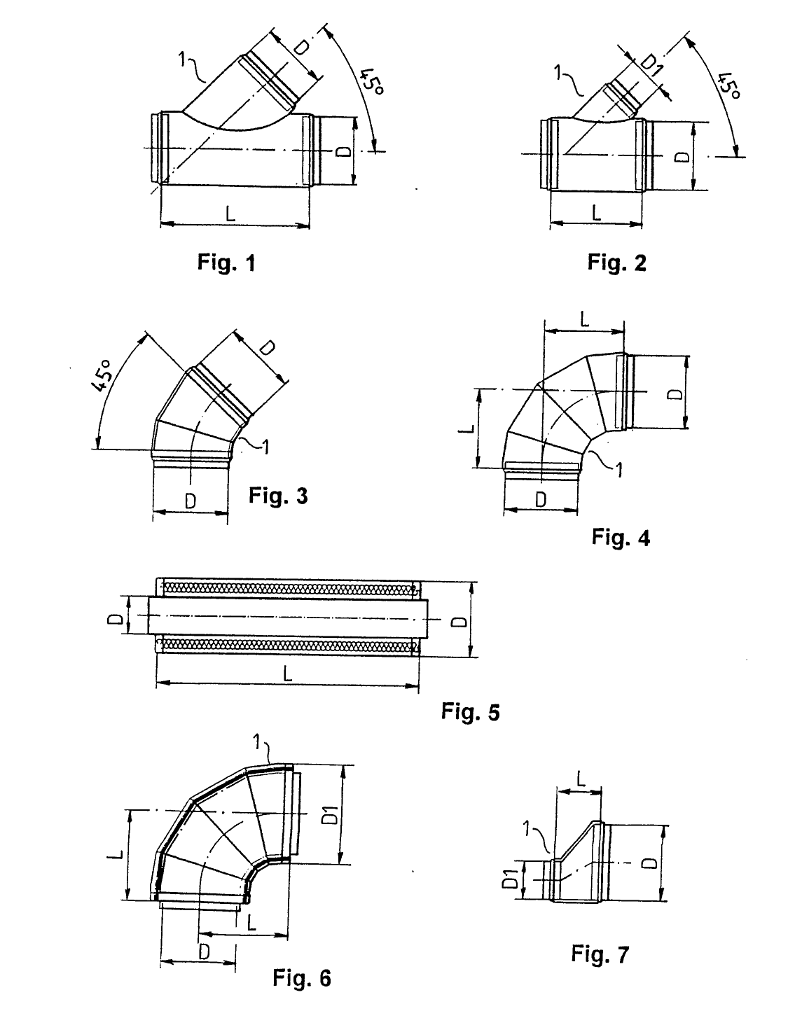

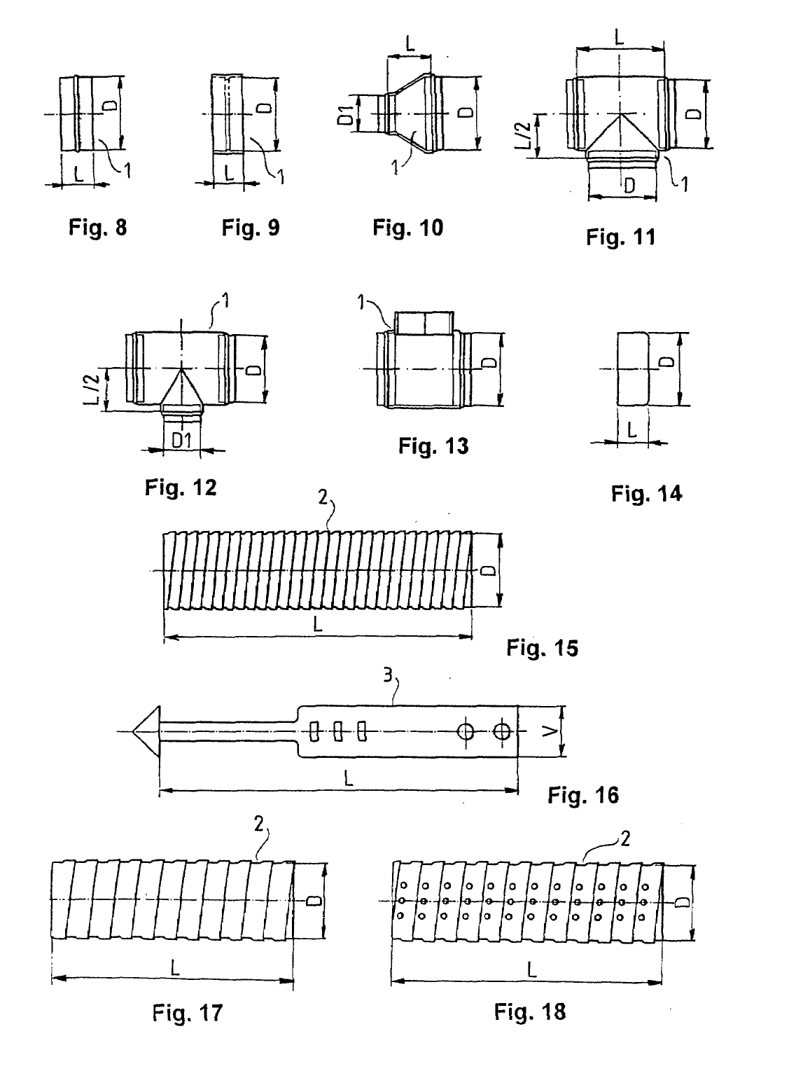

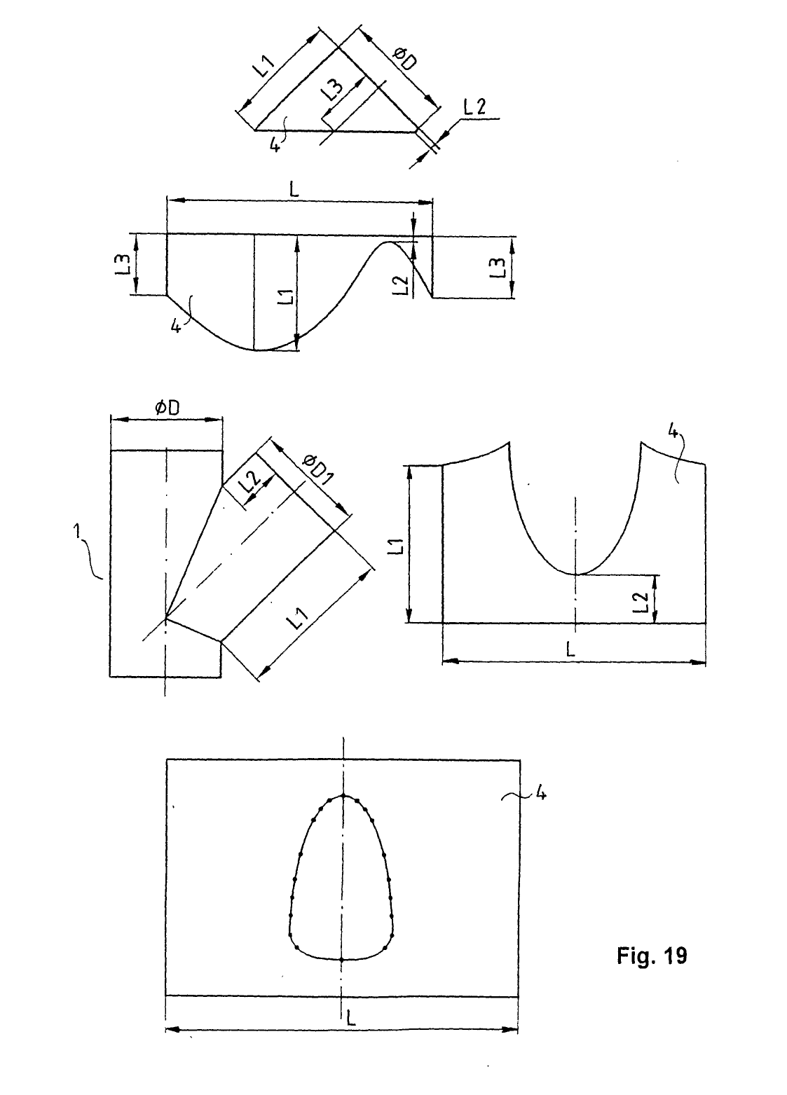

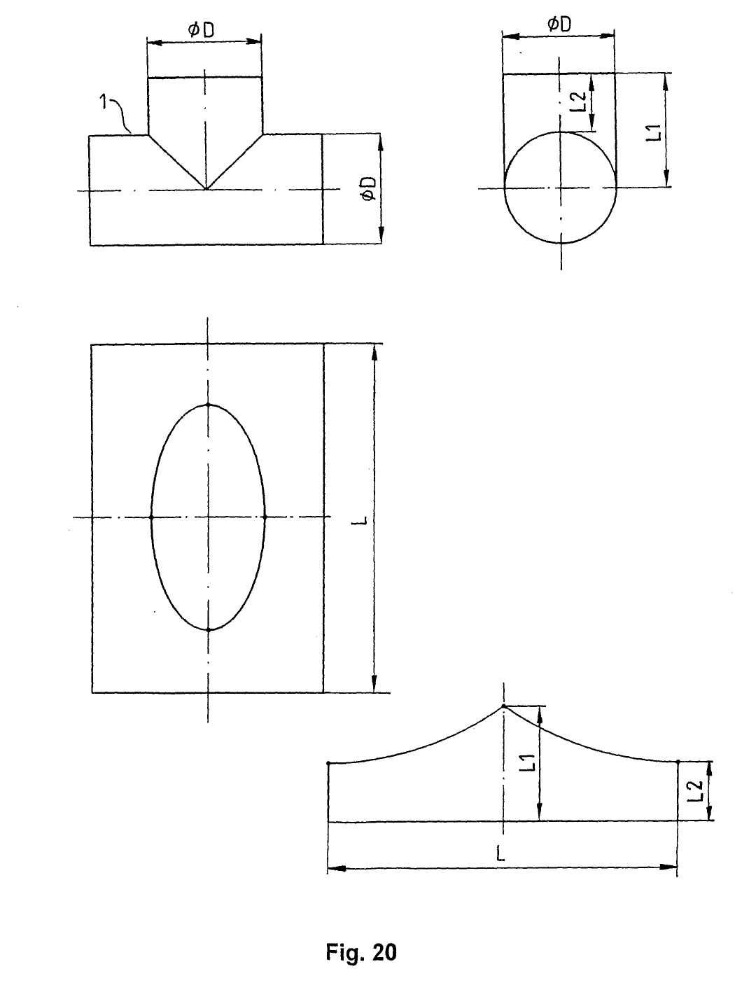

Each of the connecting components 1 shown in FIGS. 1-13 has been formed according to the method of present invention and is mainly to be used for air-handling systems. In FIG. 15 a support element 3 is to be seen applied for connecting components 1 and duct elements 2. In FIGS. 16-18 duct elements 2 are to be seen forming a part of an air-handling system and to said duct elements connecting components 1 can be coupled. In FIGS. 19 and 20 patterns 4 of several connecting components (T-Y take off-s) can be seen produced by the steps realizing the method of the present invention. Each connecting component 1 according to the invention is prepared from a foam-sheet of polyolefine. First pattern 4 of connecting component 1 is made, then the pattern 4 is cut out from the foam sheet of polyolefine, and at last the final shape of connecting component 1 is formed by welding the corresponding edges to each, other. Welding may occur anyway being applicable to the material given, hot welding is, however, preferred.

Depending on the field of end-use the foam-sheet of polyolefine forming the raw material can be covered by an evaporized metal layer. The metal layer should be outside of the end product. The other side of the foam sheet—lying inside of the end product—can be covered with a different film layer.

Connecting component 1 cut out and welded can be provided with boots on the edges to be coupled to the duct element. The boots have a double function: namely assuring the stability of the shape of the connecting component and the dimensional accuracy of coupling on one hand, and enabling quick coupling and assembling on the other hand.

The bulk density of the foam-sheet of polyolefine used for connecting component 1 of the invention depends on the measure of the connecting component 1 and is in the range of 30-90 kg/m³.

After assembling there is no need for additional heat insulation or damp-proof insulation, thus the demand for live labour is greatly decreasing.

The wall thickness of the foam-sheet of polyolefine used for connecting components 1 according to the invention is preferably between 10 and 15 mm, assuring minimal waste of heat and eliminating the condensation of vapour when used for air-conditioning purposes.

The connecting components according to the present invention may be coupled to duct elements of circular cross-section being available on the market and being used for air-channels of air-handling systems. Their design is air-impervious and aesthetic. As mentioned above it does not need any additional heat-insulation or any insulation against vapour-condensation.

In case of any failure, defect or contamination the connecting component according to the present invention should simply be replaced, the removed element itself can entirely be recycled.

The operating temperature range is preferably between 60° C. and 90° C. In this range the chemical resistivity has been found excellent.

The connecting components of the present invention can be produced by a freon-free technology without comprising any unhealthy material.

Some examples for the physical parameters of the material applied:

| | | | |
|---|---|---|---|
| Bulk density (kg/m³): | 30 ± 3 | 45 ± 6 | 90 ± 10 |
| Tensile strength (MPa): | >0.2 | >0.4 | >0.9 |
| Elongation at break (%): | >70 | >80 | >140 |
| Vapour diffusion resistance (μ): | 3800 | 4200 | 4500 |
| Linear elongation: | | max-2% | |
| Coefficient of thermal conductivity | 0.039 | 0.04 | 0.05 |
| on 10° C. (W/mK): | | | |
| Vapour diffusion resistance | 5.4 | 2.6 | 2.2 |
| (10/13 Kg/msPa) | | | |

In the air-handling systems such as commercial or industrial ventilation and air-conditioning, where the connecting component 1 according to the invention is applied, the duct elements 2 are made from polyolefine strip, too. The strips are wound up by overlapping and strengthened in the overlapping area with a plastic or metal thread. The width of the overlapping area defines the stiffness or flexibility of the duct element. The thickness of the base material varies in the range of 5 and 10 mm-s depending on the field of end-use.

In case of the most general embodiment the outer surface of the duct elements 2 and that of the connecting components 1 of a ductwork can be covered with evaporized metal layer, the inner surface is coated with another film layer, e.g. with a plastic film layer. All the elements of the air-handling system may also be coloured.

The loss of flow of both the duct element 2 (rigid or flexible) and the connecting component 1 can be defined by the flow rate of the air and by the diameter of the components.

The connecting components according to the present invention can be coupled directly to the duct elements 2 with metal boots or with other coupling elements known per se.

The duct elements 2 can be hanged on with hangers 3 or by means of any other elements known per se. The hangers can be made from the same material as that of the base material. Thus the movement and vibration of the ductwork components will not be transmitted to the construction elements of the building. On assembling the ductwork components the exact adjustment and fixation of duct elements 2 and connecting components 1 should be assured. The coupling area may be adhered and covered with a self-adhesive insulating tape.

The distance between the hangers of the duct elements depends always on the weight of duct elements 2 and connecting components 1.

1. Method for producing ductwork connecting components preferably for air-handling systems, characterized by that providing a foam-related material made of chemically cross-linked polyolefine with closed cell-structure, preparing a pattern of a connecting component from a foam-sheet of polyolefine, cutting out the pattern and forming the final shape of the connecting component by welding the corresponding edges.

2. Method according to claim 1, characterized by that welding is carried out by hot welding, preferably hot air.

3. Method according to claim 2, characterized by that the polyolefine foam sheet is preferably coated with evaporized metal layer on one side before cutting.

4. Ductwork connecting component preferably for air-handling systems, characterized by that being prepared according to claim 3 and being strengthened with metal on the connecting edges.

5. Ductwork connecting component according to claim 4, characterized by that the foam sheet of polyolefine being provided with an evaporized metal layer on one side.

6. Ductwork connecting component according claim 5, characterized by that the bulk density of the foam sheet is in the range of 30-90 kg/m³.

7. Air-handling system provided with duct elements and ductwork connecting components as claimed in claim 6.

8. Method according to claim 1, characterized by that the polyolefine foam sheet is preferably coated with evaporized metal layer on one side before cutting.

9. Ductwork connecting component preferably for air-handling systems, characterized by that being prepared according to claim 8 and being strengthened with metal on the connecting edges.

10. Ductwork connecting component according to claim 9, characterized by that the foam sheet of polyolefine being provided with an evaporized metal layer on one side.

11. Ductwork connecting component according claim 10, characterized by that the bulk density of the foam sheet is in the range of 30-90 kg/m³.

12. Air-handling system provided with duct elements and ductwork connecting components as claimed in claim 11.

13. Ductwork connecting component preferably for air-handling systems, characterized by that being prepared according to claim 2 and being strengthened with metal on the connecting edges.

14. Ductwork connecting component according to claim 13, characterized by that the foam sheet of polyolefine being provided with an evaporized metal layer on one side.

15. Ductwork connecting component according claim 14, characterized by that the bulk density of the foam sheet is in the range of 30-90 kg/m³

16. Air-handling system provided with duct elements and ductwork connecting components as claimed in claim 15.
